(19) United States
(12) Patent Application Publication
(10) Pub. No.: US 2005/0075266 A1
(43) Pub. Date: Apr. 7, 2005

(54) Polymers and process for controlling rheology of aqueous compositions

(76) Inventors: Ching-Jen Chang, Ambler, PA (US); Hailan Guo, Warrington, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 10/937,214

(22) Filed: Sep. 9, 2004

Related U.S. Application Data
(60) Provisional application No. 60/507,717, filed on Oct. 1, 2003.

(51) Int. Cl. C11D 3/50

(52) U.S. Cl. 510/515

(57) ABSTRACT

The present invention relates to a composition and process for stabilizing the rheology of softeners including fragrances and softeners including added fragrances using cationic emulsion polymers.

This invention relates to aqueous fabric softening compositions containing fragrance and surfactants. In particular, the invention concerns the use of selected emulsion polymers that stabilize the rheology of fabric softeners containing large amounts of fragrances including odorants and perfumes.

Rinse dosed fabric softeners impart desirable characteristics to washed clothing. In rinse dosed fabric softeners, fragrance is a desirable component since it imparts to the user a perception of freshness. However, introducing certain fragrances into a softener formulation or incorporating additional amounts of fragrances already present in the formulation results in an undesirable increase in the viscosity of the softener formulation over time.

European Patent Publication No. EP 1 111 034 A1 discloses combining a benefit agent (e.g. perfume) with a carrier (e.g. amine functionalized polymer) and incorporating the combination in a laundry and/or cleaning and/or surfactant and/or fabric care ingredient, characterized in that the carried benefit agent has a viscosity of at least 400 centipoises at 20° C. Polyethyleneimines are disclosed as polymeric carriers to provide the required viscosity. However, use of such polymeric carriers does not stabilize the rheology of a softener formulation including added fragrance and the publication does not teach the use of cationic polymer latexes to stabilize the rheology of fabric softeners. In addition, the impact of fragrance loading or the addition of fragrance on the viscosity of softener is not taught or disclosed.

Inventors have discovered that cationic polymer latexes can stabilize softeners incorporating fragrance and softeners incorporating added amounts of fragrance. Pre-mixing the cationic polymer latexes with one or more fragrances and then incorporating the mixture into a fabric softener stabilizes softener viscosity as compared with respective fabric softeners containing only fragrance in aging tests. Accordingly, addition of one or more cationic polymer latexes to a softener already incorporating fragrance stabilizes softener viscosity as compared with respective fabric softeners containing no cationic polymer latexes.

Accordingly, the invention provides a softener comprising: (a) one or more cationic emulsion polymers and (b) one or more fragrances; wherein addition of a mixture of (a) and (b) to the softener stabilizes the resulting softener rheology.

The invention also provides a softener including one or more fragrances comprising one or more cationic emulsion polymers, wherein addition of the cationic emulsion polymers to the softener stabilizes the resulting softener rheology.

The invention also provides a process for stabilizing the rheology of one or more softeners comprising the steps of: (a) combining one or more cationic emulsion polymers and one or more fragrances; and (b) adding the combination to the softener.

Moreover, the invention also provides a process for stabilizing the rheology of a softener including one or more fragrances comprising the step of adding one or more cationic emulsion polymers to the softener.

Polymers usefully employed in accordance with the invention are aqueous emulsion polymers having cationic functional groups as prepared and described in U.S. Pat. Nos. 3,847,857 and: 5,312,863. The cationic latex polymer compositions of the invention comprise an aqueous dispersion of cationic latex polymeric binder particles. The cationic polymer particles may be prepared by any polymerization technique known in the art, such as for example suspension polymerization, interfacial polymerization or emulsion polymerization, from at least one monoethylenically unsaturated monomer, or mixtures of such monomers, provided that at least one of said monomers has a weak base or quaternary ammonium functionality or is capable of being imparted with such functionality. The ability of such a polymer to be imparted with such functionality is described in more detail hereinafter.

According to one embodiment of the invention, emulsion polymerization of ethylenically unsaturated monomers in the presence of certain surfactants is used as a polymerization technique because the aqueous dispersion of latex polymer particles so formed in this process can be used directly or with minimal work-up in preparing the aqueous emulsion polymers of the present invention.

Emulsion techniques for preparing aqueous dispersions of latex polymeric particles from ethylenically unsaturated monomers are well known in the polymer art. Single and multiple shot batch emulsion processes can be used, as well as continuous emulsion polymerization processes. In addition, if desired, a monomer mixture can be prepared and added gradually to the polymerization vessel. Similarly, the monomer composition within the polymerization vessel can be varied during the course of the polymerization, such as by altering the composition of the monomer being fed into the polymerization vessel. Both single and multiple stage polymerization techniques can be used. The latex polymer particles can be prepared using a seed polymer emulsion to control the number of particles produced by the emulsion polymerization as is known in the art. The particle size of the latex polymer particles can be controlled by adjusting the initial surfactant charge as is known in the art.

A polymerization initiator can be used in carrying out the polymerization of the cationic polymer particles. Examples of polymerization initiators which can be employed include polymerization initiators which thermally decompose at the polymerization temperature to generate free radicals. Examples include both water-soluble and water-insoluble species. Examples of free radical-generating initiators which can be used include persulfates, such as ammonium or alkali metal (potassium, sodium or lithium) persulfate; azo compounds such as 2,2′-azobis(isobutyronitrile), 2,2′-bis(2,4-dimethyl-valeronitrile), and 1-t-butyl hydroperoxide and cumene hydroperoxide; peroxides such as benzoyl peroxide, caprylyl peroxide, di-t-butyl peroxide, ethyl 3,3′-di(t-butylperoxy)butyrate, ethyl 3,3′-di(t-amylperoxy)butyrate, t-amylperoxy-2-ethyl heanoate, and t-butylperoxy pivilate; peresters such as t-butyl peracetate, t-butyl perphthalate, and t-butyl perbanzoate; as well as percarbonates, such as di(1-cyano-1-methylethyl)peroxy dicarbonate; perphosphates, and the like.

Polymerization initiators can be used alone or as the oxidizing component of a redox system, which also includes a reducing component such as ascorbic acid, maleic acid, glycolic acid, oxalic acid, lactic acid, thiogycolic acid, or alkali metal sulfite, more specifically hydrosulfite, hyposulfite or metbisulfite, such as sodium hydrosulfite, potassium hyposulfite and potassium metabisufite, or sodium formaldehyde sulfoxylate. The reducing component is frequently referred to as an accelerator.

The initiator and accelerator, commonly referred to as catalyst, catalyst system or redox system, can be used in concentrations of from about 0.001% to 5% each, based on the weight of monomers to be co-polymerized. Accelerators such as chloride and sulfate salts of cobalt, iron, nickel, or copper can be used in small amounts. Examples of redox catalyst systems include tert-butyl hydroperoxide/sodium formaldehyde sulfoxylate/Fe(II), and ammonium persulfate/sodium bisulfite/sodium hydrosulfite/Fe(II). The polymerization temperature can be from room temperature to about 90° C., and can be optimized for the catalyst system employed, as is conventional.

Chain transfer agents can be used to control polymer molecular weight, if desired. Examples of chain transfer agents include mercaptans, polymercaptans and polyhalogen compounds. Examples of chain transfer agents which may be used include alkyl mercaptans such as ethyl mercaptan, n-propyl mercaptan, n-butyl mercaptan, isobutyl mercaptan, t-butyl mercaptan, n-amyl mercaptan, isoamyl mercaptan, t-amyl mercaptan, n-hexyl mercaptan, cyclohexyl mercaptan, n-octyl mercaptan, n-decyl mercaptan, n-dodecyl mercaptan; alcohols such as isopropanol, isobutanol, lauryl alcohol, t-octyl alcohol, benzyl alcohol, and alpha-methylbenzyl alcohol; halogenated compounds such as carbon tetrachloride, tetrachloroethylene, and trichlorobromethane. Generally from 0 to 10% chain transfer agent by weight, based on the weight of the monomer mixture, can be used. The polymer molecular weight can be controlled by other techniques known in the art, such as by selecting the ratio of initiator to monomer.

Catalyst and/or chain transfer agent can be dissolved or dispersed in separate or the same fluid medium, can be added simultaneously with the catalyst and/or the chain transfer agent. Amounts of initiator or catalyst can be added to the polymerization mixture after polymerization has been substantially completed to polymerize the residual monomer as is well known in the polymerization art.

Aggregation of the latex polymer particles can be discouraged by inclusion of a micelle-forming, stabilizing surfactant in the polymerization mix. In general, the growing core particles are stabilized during emulsion polymerization by one or more surfactants, at least one of said surfactants being a non-ionic or amphoteric surfactant or mixtures thereof. These types of surfactants are well known in the emulsion polymerization art. Many examples of suitable surfactants are given in McCutchen's Detergents and Emulsifiers (MC Publishing Co., Glen Rock, N.J.), published annually. Other types of stabilizing agents, such as protective colloids, can also be used.

In the preparation of the cationic polymer latex, the proportion of any anionic or cationic surfactant should be minimized relative to the concentration of the non-ionic and amphoteric surfactants used, so that the addition of the aqueous dispersion of the cationic latex polymer particles contributes minimal anionic or cationic surfactant to the softener composition, and minimizes interference with the adhesion of the softener to anionic substrates. Cationic surfactants at concentrations below about 1 percent by weight on polymer latex may be tolerated, but concentrations of such surfactants of about 1 percent on latex and higher, depending on the structure of the surfactant, may significantly compromise utility by competing with the cationic latex for anionic binding sites in the softener. Anionic surfactants are also undesirable in that they will complex with the cationic latex sites. It is preferred that the concentration of anionic surfactant on a molar basis be less than 50% of the molar amount of weak base or quaternary functionality. As indicated above it is most desirable to use non-ionic and amphoteric surfactants. A mixture of the two being the most preferred for the best balance of properties. The amphoteric surfactants are desirable in that they act to improve corrosion resistance as taught by U.S. Pat. Nos. 2,926,108 and 3,336,229.

Examples of suitable anionic surfactants include the ammonium, alkali metal, alkaline earth metal, and lower alkyl quaternary ammonium softs of: sulfosuccinates such as di(C7-C25)alkylsulfosuccinate; sulfates such as the higher fatty alcohol sulfates, for example, lauryl sulfate; sulfonates including aryl sulfonates, alkyl sulfonates, and the alkylaryl sulfonates, for example, isopropylbenzene sulfonate, isopropylnaphthalene sulfonate and N-methyl-N-palmitoyltaurate, isothionates such as oleyl isothionate; and the like. Additional examples include the alkylarylpoly(ethyleneoxy)ethylene sulfates, sulfonates and phosphates, such as t-octylphenoxypoly(ethylenoxy)ethylene sulfates and nonylphonoxy-poly(ethyleneoxy)ethylene phosphates, either having 1 to 7 oxyethylene units.

Examples of suitable non-ionic surfactants include poly(oxyalkylene) alkyphenol ethers, poly(oxyalkylene)alkyl ethers, poly(oxyalkylene)esters of fatty acids, polyethyleneoxidepolypropyleneoxide block copolymers, and the like.

Examples of suitable cationic surfactants include quaternary alkyl ammonium halides, phosphates, acetates, nitrates, sulfates; polyoxyalkyleneamines, poly(ethyleneoxide)amine, polyoxyalkylamine oxides, substituted imidazoline of alkyl fatty acids, alkylbenzyldimethylammonium halides, and alkyl pyridinium halides.

Examples for suitable amphoteric surfactants include imidiazoline derived amphoteric surfactants, as described in U.S. Pat. No. 5,312,863, wherein R is selected from the group consisting of straight and branched chain fatty acids and where the alkylene group has 8 to 20 carbon atoms; wherein R1 is selected from: —((CH2)xO)y-R′ where x=2 and 3, y=0 to 6, R′=H, straight and branched chain fatty acids, and alcohols having 2 to 12 carbon atoms; and wherein R2 is selected from the group consisting of branched, straight chain aliphatic and aromatic carboxylic acids, sulfonic acids, phosphoric acids where the alkylene group has 1 to 18 carbon atoms. Other carboxybetaines, sulfatobetaines, sulfitobetaines, sulfobetaines, phosphoniobetaines, N-alkylamino acids and the like are also suitable.

In emulsion polymerization an aqueous polymerization medium is employed. The aqueous medium includes water and can include soluble inorganic salts, non-reactive water-miscible co-solvents such as lower alkanols and polyols, buffering agents, soluble and dispersible polymeric materials including protective colloids, and thickening and suspending agents such as polyvinyl alcohol, methoxycellulose, and hydroxyethylcellulose.

The cationic functional polymer particles of the invention are polymerized from one or more monomers, including at least one polymerizable ethylenically unsaturated monomer, wherein at least one of said monomers contains a cationic functional group such as, for example, an acid protonated amine functional group or a quaternary ammonium functionality or is capable of being modified, after it is polymerized, to contain a cationic functional group such as, for example, an acid protonated amine functional group or a quaternary ammonium functionality. The monomer can be a single weak cationic-functional, polymerizable ethylenically unsaturated monomer species, or a precursor of such a species, such as a polymerizable ethylenically unsaturated monomer which can be modified after polymerization to provide the necessary cationic functionality. These monomers shall be referred to hereinafter collectively as “cationic functional monomers”. Alternatively, a monomer mixture which includes one or more polymerizable ethylenically unsaturated monomer species, or a precursor of such a species, may be employed, and shall also be considered within the above definition of cationic functional monomers.

The concentration of the cationic functional monomer preferably ranges from 0.5 to 15 percent by weight of the total polymerizable monomers used to prepare the polymeric binder, and more preferably from 1 to 5 percent by weight.

Examples of suitable cationic functional monomers include monoethylenically unsaturated monomers containing the group —HC═C— and a weak-base amino group or radicals, and polyethylenic amines which polymerize monoethyenically, such as weak-base amine substituted butatriene. The properties of basic monomers, including alkenyl pyridines and alkylamino (meth)acrylates are reviewed by L. S. Luskin in Functional Monomers, Volume 2 (R. H. Yocum and E. B. Nyquist, eds., Marcel Dekker, Inc. New York 1974) at 555-739.

Examples of amine-functional monethylenically unsaturated monomers include those monomers having structures as described in U.S. Pat. No. 5,312,863.

Examples of the compounds include: 10-aminodecyl vinyl ether, 9-aminooctyl vinyl ether, 6-(diethylamino)hexyl(meth)acrylate, 2-(diethylamino)ethyl vinyl ether, 5-aminopentyl vinyl ether, 3-aminopropyl vinyl ether, 2-aminoethyl vinyl ether, 2-aminobutyl vinyl ether, 4-aminobutyl vinyl ether, 3-(dimethylamino)propyl(meth)acrylate, 2-(dimethylamino)ethyl vinyl ether, N-(3,5,5-trimethylhexyl)aminoethyl vinyl ether, N-cyclohexylaminoethyl vinyl ether, 3-(t-butylamino)propyl(meth)acrylate, 2-(1,1,3,3-tetramethylbutylamino)ethyl(meth)acrylate, N-t-butylaminoethyl vinyl ether, N-methylaminoethyl vinyl ether, N-2-ethylhexylaminoethyl vinyl ether, N-t-octylaminoethyl vinyl ether, beta-morpholinoethyl(meth)acrylate, 4-(beta-acryloxyethyl) pyridine, beta-pyrrolidinoethyl vinyl ether, 5-aminopentyl vinyl sulfide, beta-hydroxyethylaminoothyl vinyl ether, (N-beta-hydroxyethyl-N-methyl) aminoethyl vinyl ether, hydroxyethyldimethyl(vinyloxyethyl) ammonium hydroxide, 2-(diemthylamino)ethyl(meth)acrylate, 2-(dimethylamino)ethyl(meth)acrylamide, 2-(t-butylamino)ethyl(meth)acrylate, 3-(dimethylamino)propyl(meth)acrylamide, 2-(diethylamino)ethyl(meth)acrylate, and 2-(dimethylamino)ethyl(meth)acrylamide. Examples of amine-functional ethylenically unsaturated monomers include: 4-vinyl pyridine 2,6-diethyl-4-vinyl pyridine, 3-dodecyl-4-vinyl pyridine, and 2,3,5,6,-tetramethyl-4-vinyl pyridine.

As used herein, the expression “(meth)acrylate” is intended as a generic term embracing both acrylic acid and methacrylic acid esters. Similarly, “(meth)acrylamide” embraces both the methacrylamides and acrylamides.

The quaternized form of weak base functional monomers, such as weak base functional monomers which have been reacted with alkyl halides, such as for example, benzyl chloride or with epoxides, such as propylene oxide, or with dialkyl sulfates, such as dimethyl sulfate can also be used.

For the purpose of this invention such monomers shall be included within the description “cationic functional” monomers. This alkylation reaction is particularly necessary for weak base amine monomers that are significantly weaker in base strength than dimethyl aminopropyl methacrylamide (DMAPMA).

Some quaternized forms of weak base monomers are very water soluble and may be difficult to incorporate into latex polymers by emulsion polymerization. An alternate method of making a quaternary amine functional latex dispersion is to post-functionalize a latex after emulsion polymerization. This can be done as described in U.S. Pat. No. 3,926,890 where haloalkyl ester monomers such as for example 2-chloroethyl acrylate and the like, are incorporated into a latex. These latexes are then post-alkylated by reaction with tertiary amines. Alternately, latexes can be made with glycidyl monomers like glycidyl methacrylate and post reacted with amines (tertiary amines to form quaternary groups) as taught in U.S. Pat. No. 3,969,296.

Additionally, weak base functional latexes can also be post-reacted with alkylating agents such as, for example, benzyl chloride, and epoxides as discussed above for monomers.

Instead of preparing the cationic functional polymer particles by polymerization of monomers including a cationic functional group, the particles can be prepared by first polymerizing one or more monomers which do not include weak base-functional groups, and then functionalizing the polymer with an agent which provides a weak base-functional group.

In addition to the weak base-functional monomer, other ethylenically unsaturated monomers which are polymerizable with the weak base functional monomer can also be used in preparing the cationic latex polymer particles of the present invention. For example, co-polymerizable ethylenically unsaturated nonionic monomers can be employed. Examples of nonionic monethyenically unsaturated monomers which can be used include styrene, alpha-methyl styrene, vinyl toluene, vinyl naphthalene, ethylene, vinyl acetate, vinyl versatate, vinyl chloride, vinylidene chloride, acrylonitrile, methacrylonitrile, (meth)acrylamide, various (C1-C20)alkyl and (C3-C20)alkenyl esters of (meth)acrylic acid; for example, methyl(meth)acrylate, ethyl(meth)acrylate, n-butyl(meth)acrylate, isobutyl(meth)acrylate, 2-ethylhexyl(meth)acrylate, cyclohexyl(meth)acrylate, n-octyl(meth)acrylate, n-decyl(meth)acrylate, n-dodecyl(meth)acrylate, tetradecyl(meth)acrylate, n-amyl(meth)acrylate, neopentyl(meth)acrylate, cyclopentyl(meth)acrylate, lauryl(meth)acrylate, oleyl(meth)acrylate, palmityl (meth)acrylate, and stearyl(meth)acrylate; other (meth)acrylates such as isobornyl(meth)acrylate, benzyl(meth)acrylate, phenyl(meth)acrylate, 2-bromethyl(meth)acrylate, 2-phenylethyl(meth)acrylate, and 1-naphthyl (meth)acrylate; alkoxylalkyl(meth)acrylates such as ethoxyethyl(meth)acrylate; and dialkyl esters of ethylenically unsaturated di- and tricarboxylic acids and anhydrides, such as diethyl maleate, dimethyl fumarate, trimethyl aconitate, and ethyl methyl itaconate.

The ethylenically unsaturated monomer can also include up to 10% by weight of at least one multi-ethylenically unsaturated monomer to raise the average molecular weight and to cross-link the polymer. Examples of multi-ethylenically unsaturated monomers which can be used include allyl (meth)acrylate, tripropyleneglycol di(meth)acrylate, diethyleneglycol di(meth)acrylate, ethyleneglycol di(meth)acrylate, 1,6-hexanediol di(meth)acrylate, 1,3-butyleneglycol di(meth)acrylate, polyalkylene glycol di(meth)-acrylate, diallyl phthalate, trimethylolpropane tri(meth)acrylate, divinyl benzene, divinyl toluene, trivinyl benzene and divinyl naphthalene. Non-ionic monomers including functional groups which can serve as sites for post-polymerization cross-linking can be included in lieu of or in addition to multi-ethylenically unsaturated monomers. For example, epoxy-functional ethylenically unsaturated monomers, such as glycidyl methacrylate, amine-functional ethylenically unsaturated monomers such as methyl acrylamidoglycolate methyl ether, and the like, can be employed. However, the polymerization conditions should be selected to minimize reaction, if any, between the cationic functional group and the post-polymerization cross-linkable functional group. After polymerization, an appropriate multi-functional cross-linking agent can be reacted with cross-linkable functional groups pendant from the polymer chain. Alternatively, the cationic functional group itself can serve as a cross-linking site. Other means of cross-linking the polymer particles known in the art, such as by high energy particles and radiation, can also be employed.

It is necessary to protonate the amine functional polymer particles to make the polymer particles cationic by the addition of one or more acids to the aqueous dispersion of amine functional polymer particles. The interaction of such acid protonated amine functional polymers to anionic components in softeners is related to the pH of the aqueous dispersion of the polymer particles. The pH of the aqueous dispersion containing the polymer particles which results simultaneously in the maximum concentration of protonated amine groups on the emulsion polymer and anionic groups in the softener gives the maximum ionic interaction between the softener components and the polymer. Interaction is at a maximum at the pH which yields an equal concentration of the two interacting species. For example, at low pHs such as, for example, at pH below 4 the concentration of carboxyl groups present in the ionized form is low. At high pH such as, for example, at pH above 8 the concentration of amine groups in the protonated state will be low. The pH range of maximum interaction of the polymer and softener components occurs when the number of substrate carboxyl groups in the ionized carboxylate form is equal to polymeric binder protonated amine groups at the interface between the two. If very few carboxyl groups are present, the pH of maximum interaction will be shifted to a higher pH than for the case of equal concentrations of carboxyl and amine functional groups hereinafter referred to as “maximum ionic bonding”. If high concentrations of both interacting species are present at the polymer softener interface, the interaction may be maximized, without a high dependence on pH.

Inventors have observed that the pH range where the maximum ionic bonding (MIB) of the cationic polymeric latex on anionic components of the softener occurs depends on the base strength of the amine functional latex. The stronger the base strength of the polymer, the broader the pH range where MIB and good interaction is observed. As the base strength of the amine functional polymer increases, the pH of maximum adhesion will shift to correspondingly higher pH values. In general the pH of the aqueous dispersion of cationic polymer particles should not be raised above pH 9 and should not be below pH 2, and should be in the range of 5 to 8.

Quaternary ammonium functional latexes have been observed to have the widest pH-interaction range. This is believed to be due to the quaternary ammonium functionality providing a pH independent level of cationic charge. For the ionic bonding mechanism discussed above, the amine functional groups in the polymer may be primary, secondary, tertiary, or quaternary amines The chemical type is not important, only their base strength is of importance. MIB may also be achieved at higher pH if the concentration of the amine functional monomer is increased.

Certain acids which could be used to protonate the amine functional polymer particles can compromise the interaction of the polymer, as well as softeners containing the emulsion polymer, to anionic components of the softener. In particular, acids which are strongly selective for amine functional resins (“selective” having the meaning used in ion exchange resin technology context) should not be used in softeners to neutralize or protonate the amine functional latex, or as the counterion for the dispersants used in the polymer composition. Particularly, aromatic sulfonic acids, hydrophobic acids such as for example oleic, octanoic, and the like, and polyvalent acids such as citric acid and the like, should be avoided. Acids which have a strong selectivity for amine groups on the amine functional latexes will complex these amine groups making them unavailable for interacting with anionic substrates. They also reduce the efficiency of cationic, amine-based dispersants.

The most desirable acids which we have found for the neutralization or protonation of the amine functional polymeric binder particles are monoprotic, organic acids such as for example acetic acid, lactic acid, and the like. Inorganic acids such as, for example, hydrochloric acid may also be used, but they generally hurt the water resistance and the corrosion resistance of the coatings. The significant factors in determining the selectivity of acid used for partially protonating amine functional polymers includes the valence of the acid anion, the ionic radius of the acid molecule, the relative strength of the acid and the molecular structure or geometry of the acid molecule as taught in Doulite Ion-Exchange Manual, edited by technical staff of the Resinous Products Division of Diamond Shamrock Company, Copyright 1969, Diamond Shamrock Corp. Hydrophobic acids, such as for example oleic acid, tend to form insoluble liposalts with hydrophobic amines, such as for example, the amine functional emulsion polymer particles. We have found a preference, therefore, for C1-C6 monocarboxylic acids, formic, acetic acid, propionic, lactic acid and other lower molecular weight organic acids.

Cationic dispersants as described in U.S. Pat. Nos. 3,847,857 and 5,312,863 are usefully employed in accordance with the invention.

According to one embodiment of the invention, suitable cationic emulsion polymers include, but are not limited to, latex polymer particles having cationic functional groups. The polymer may be prepared in two forms:
Type I-A polymeric dispersion of highly cross-linked, non-thermoplastic, non-film forming, spherical particles which range in size from 0.05 to 0.31 μm in diameter; These particles may be isolated by freeze-drying or spray-drying and can be reconstituted in either water or oil.
Type II-A polymeric dispersion of non-cross-linked to slightly cross-linked, thermoplastic, film forming, spherical particles which range in size from 0.1 to 1.0 μm in diameter. Type II polymer can also serve as a binder.

Type I contains higher quantities of the quaternary or tertiary amine cation. However, either polymer can be used alone or in conjunction with each other. If used in conjunction, Type I and Type II tend to reinforce each other and are more effective than a like quantity used alone. If used alone, Type I requires the addition of a binder, whereas Type II is its own binder.

Copolymers of this invention are prepared by emulsion polymerization and provide, directly, spherical resins having a particle size in the range of from 0.05 to 0.3 microns.

Groups at the polymer interface are rate determining; polymer particles with a high surface area to volume ratio are more effective. Thus, polymers prepared by emulsion polymerization are significantly more effective than if the same compositions were prepared by suspension polymerization. For example, emulsion polymer particles 0.1 microns in diameter have a surface to volume ratio one hundred times as great as a suspension polymer with a diameter of 10 microns. A particle size of 10 microns is considered small for suspension polymers. A more typical value is 100 microns while a particle size of 0.1 microns to 0.2 micron diameter is normal for a polymer prepared by emulsion polymerization.

In one embodiment of the invention, cationic emulsion polymers are provided which contain either:
(A) A dispersed cross-linked water-insoluble vinyl addition emulsion copolymer of a mixture of:
(1) from 5 to 70% by weight and preferably from 25 to 65% by weight of one or more monomer units containing an amine or quaternary ammonium group in base or salt form;
(2) from 1 to 50%, including from 3 to 25% by weight of one or more polyethylenically unsaturated cross-linking monomer units; and
(3) from 0 to 80% by weight (to make 100%) of one or more monoethylenically unsaturated monomer units of neutral or non-ionic character;
or (B) a dispersed, water-insoluble, linear or cross-linked vinyl addition emulsion copolymer of a mixture of:
(1) from 5 to 70% by weight, including from 25 to 65% by weight of one or more monomer units containing an amine or quaternary ammonium group in salt form;
(2) from 0 to 50% and preferably from 3 to 25% by weight of one or more polyethylenically unsaturated cross-linking monomer units: and
(3) from 0 to 89% by weight (to make 100%) of one or more monoethylenically unsaturated monomer units of neutral or non-ionic character, the counter-ion of the salt being a metal counter-ion in aqueous media, especially counter-ions derived from boron, chromium, molybdenum and tungsten. The resulting compositions are effective at stabilizing the rheology of softeners containing fragrance or the addition of fragrance to softeners.

The dispersed copolymer in (A) may contain quaternary ammonium groups cross-linked as a result of the use of a di-functional alkylating agent, in which case the polyethylenically unsaturated monomer may be partially or completely omitted. Similarly, the dispersed copolymer in (B) may contain quaternary ammonium groups cross-linked as a result of the use of a di-functional alkylating agent whether or not a cross-linking polyethylenically unsaturated monomer is used in making the copolymer. As used herein, the terms “polyethylenically” and “multi-ethylenically” refer to monomers having a plurality of ethylenically unsaturated groups.

According to one embodiment of the invention, aqueous dispersions of the invention may be made using one or more emulsifiers of anionic, cationic, or non-ionic type. Mixtures of two or more emulsifiers regardless of type may be used, except that it is generally undesirable to mix a cationic with an anionic type in any appreciable amounts since they tend to neutralize each other. The amount of emulsifier may range from 0.1 to 6% by weight, including sometimes even more, based on the weight of the total monomer charge. When using a persulfate type or, in general, an ionic type of initiator, the addition of emulsifiers is often unnecessary and this omission or the use of only a small amount, e.g., less than about 0.5% by weight of emulsifier, may sometimes be desirable from the cost standpoint (elimination of expensive emulsifier). The particle size or diameter of these dispersed polymers is from about 0.05 to 1.0 microns. The particle size whenever referred to herein, is the “number average diameter.” This number, expressed in microns, is determined using the dissymmetry light-scatter method or the electron microscope. A description of the light-scatter method can be found in the Journal of Colloid Science 16, pages 561 to 580, 1961 (Dezelic and Kratohoic). In general, the molecular weight of these emulsion polymers are high, e.g., from about 100,000 to 10,000,000 and the polymers have viscosities typically averaging above 500,000 centipoise as measured using a conventional Brookfield rheometer (frequency 12 and spindle 2) at 20° C.

Typical fabric care products such as laundry detergent compositions and fabric softener compositions contain 0.5% to 1% by weight fragrance in their formulations. U.S. Pat. No. 6,051,540 discloses that in the course of the washing process wherein clothes are washed with the standard powdered laundry detergent, or fabric softener rinse, a small fraction of the fragrance that is contained in these fabric care products is actually transferred to the clothes. Tests are described showing that the amount of fragrance that is left as a residue on the clothes can be as low as 1% of the original small amount of fragrance that is contained in these products formulation itself.

As is well known, a perfume normally consists of a mixture of a number of perfumery materials, each of which has a fragrance. The number of perfumery materials in a perfume is typically ten or more. The range of fragrant materials used in perfumery is very wide; the materials come from a variety of chemical classes, but in general are water-insoluble oils. In many instances, the molecular weight of a perfumery material is in excess of 150, but does not exceed 3000.

Perfumes used in the present invention include mixtures of conventional perfumery materials. Suitable perfumes and fragrances include: acetyl cedrene, 4-acetoxy-3-pentyltetrahydropyran, 4-acetyl-6-t-butyl-1,1-dimethylindane, available under the trademark “CELESTOLIDE”, 5-acetyl-1,1,2,3,3,6-hexamethylindane, available under the trademark “PHANTOLIDE”, 6-acetyl-1-isopropyl-2,3,3,5-tetramethylindane, available under the trademark “TRASEOLIDE”, alpha-n-amylcinnamic aldehyde, amyl salicylate, aubepine, aubepine nitrile, aurantion, 2-t-butylcyclohexyl acetate, 2-t-butylcyclohexanol, 3-(p-t-butylphenyl)propanal, 4-t-butylcyclohexyl acetate, 4-t-butyl-3,5-dinitro-2,6-dimethyl acetophenone, 4-t-butylcyclohexanol, benzoin siam resinoids, benzyl benzoate, benzyl acetate, benzyl propionate, benzyl salicylate, benzyl isoamyl ether, benzyl alcohol, bergamot oil, bornyl acetate, butyl salicylate, carvacrol, cedar atlas oil, cedryl methyl ether, cedryl acetate, cinnamic alcohol, cinnamyl propionate, cis-3-hexenol, cis-3-hexenyl salicylate, citronella oil, citronellol, citronellonitrile, citronellyl acetate, citronellyloxyacetaldehyde, cloveleaf oil, coumarin, 9-decen-1-ol, n-decanal, n-dodecanal, decanol, decyl acetate, diethyl phthalate, dihydromyrcenol, dihydromyrcenyl formate, dihydromyrcenyl acetate, dihydroterpinyl acetate, dimethylbenzyl carbinyl acetate, dimethylbenzylcarbinol, dimethylheptanol, dimethyloctanol, dimyrcetol, diphenyl oxide, ethyl naphthyl ether, ethyl vanillin, ethylene brassylate, eugenol, geraniol, geranium oil, geranonitrile, geranyl nitrile, geranyl acetate, 1,1,2,4,4,7-hexamethyl-6-acetyl-1,2,3,4-tetrahydronaphthalene, available under the trademark “TONALID”, 1,3,4,6,7,8-hexahydro-4,6,6,7,8,8-hexamethylcyclopenta-2-benzopyran, available under the trademark “GALAXOLIDE”, 2-n-heptylcyclopentanone, 3a,4,5,6,7,7a-hexahydro-4,7-methano-1(3)H-inden-6-ylpropionate, available under the trademark “FLOROCYCLENE”, 3a,4,5,6,7,7a-hexahydro-4,7-methano-1(3)H-inden-6-ylacetate, available under the trademark “JASMACYCLENE”, 4-(4′-hydroxy-4′-methylpentyl)-3-cyclohexenecarbaldehyde, alpha-hexylcinammic aldehyde, heliotropin, Hercolyn D, hexyl aldone, hexyl cinnamic aldehyde, hexyl salicylate, hydroxycitronellal, i-nonyl formate, 3-isocamphylcyclohexanol, 4-isopropylcyclohexanol, 4-isopropylcyclohexyl methanol, indole, ionones, irones, isoamyl salicylate, isoborneol, isobornyl acetate, isobutyl salicylate, isobutylbenzoate, isobutylphenyl acetate, isoeugenol, isolongifolanone, isomethyl ionones, isononanol, isononyl acetate, isopulegol, lavandin oil, lemongrass oil, linalool, linalyl acetate, LRG 201, 1-menthol, 2-methyl-3-(p-isopropylphenyl)propanal, 2-methyl-3-(p-t-butylphenyl)propanal, 3-methyl-2-pentyl-cyclopentanone, 3-methyl-5-phenyl-pentanol, alpha and beta methyl naphthyl ketones, methyl ionones, methyl dihydrojasmonate, methyl naphthyl ether, methyl 4-propyl phenyl ether, Mousse de chene Yugo, Musk ambrette, myrtenol, neroli oil, nonanediol-1,3-diacetate, nonanol, nonanolide-1,4, nopol acetate, 1,2,3,4,5,6,7,8-octahydro-2,3,8,8-tetramethyl-2-acetyl-naphthalene, available under the trademark “ISO-E-SUPER”, octanol, Oppoponax resinoid, orange oil, p-t-amylcyclohexanone, p-t-butylmethylhydrocinnamic aldehyde, 2-phenylethanol, 2-phenylethyl acetate, 2-phenylpropanol, 3-phenylpropanol, para-menthan-7-ol, para-t-butylphenyl methyl ether, patchouli oil, pelargene, petitgrain oil, phenoxyethyl isobutyrate, phenylacetaldehyde diethyl acetal, phenylacetaldehyde dimethyl acetal, phenylethyl n-butyl ether, phenylethyl isoamyl ether, phenylethylphenyl acetate, pimento leaf oil, rose-d-oxide, Sandalone, styrallyl acetate, 1,1,4,4-tetramethyl-6-acetyl-7-ethyl-1,2,3,4-tetrahydronaphthalene, available under the trademark “VERSALIDE”, 3,3,5-trimethyl hexyl acetate, 3,5,5-trimethylcyclohexanol, terpineol, terpinyl acetate, tetrahydrogeraniol, tetrahydrolinalool, tetrahydromuguol, tetrahydromyrcenol, thyme oil, trichloromethylphenylcarbinyl acetate, tricyclodecenyl acetate, tricyclodecenyl propionate, 10-undecen-1-al, gamma undecalactone, 10-undecen-1-ol, undecanol, vanillin, vetiverol, vetiveryl acetate, vetyvert oil, acetate and propionate esters of alcohols in the list above, aromatic nitromusk fragrances indane musk fragrances isochroman musk fragrances macrocyclic ketones, macrolactone musk fragrances and tetralin musk fragrances. Other suitable examples of fragrances and perfumes are described in European Patent Publication EP 1 111 034 A1.

Perfumes frequently include solvents or diluents, for example: ethanol, isopropanol, diethylene glycol monoethyl ether, dipropylene glycol, diethyl phthalate and triethyl citrate.

Perfumes which are used in the invention may, if desired, have deodorant properties as disclosed in U.S. Pat. No. 4,303,679, U.S. Pat. No. 4,663,068 and European Patent Publication EP 0 545 556 A1.

According to one embodiment of the invention, when cationic emulsion polymers are impregnated with perfume after pre-mixing, inventors have found that the absorption of perfume can be enhanced by choosing perfumery materials with a hydrophobic character or mixing a hydrophobic oil into the perfume. Suitable examples of hydrophobic oils which can enhance perfume uptake include: dibutylphthalate, alkane mixtures such as isoparaffin and di(C8-C10 alkyl)propylene glycol diester.

Perfume-carrying particles are incorporated in fabric conditioning products used during rinsing of fabrics. The main benefits delivered by such products are softness, fragrance and anti-static. Softness is usually the most important.

A fabric softening product contains at least one softening agent which functions to give the fabric a softer handle. Frequently such agents also provide an anti-static benefit. Such agents are usually cationic but may be non-ionic, amphoteric or zwitterionic materials.

Many fabric softening products take the form of compositions intended to be added to rinse water. The fabric softening agents are then materials with low solubility in water, and which deposit on the fabrics. Typically the solubility in acidified water at 20° C. is less than 10 g/litre, preferably less than 1 g/litre. When added to rinse water such materials form a dispersed phase which is then able to deposit on fabrics which are being rinsed in the water.

Many commercially important fabric softening agents are organic compounds containing quaternary nitrogen and at least one carbon chain of 6 to 30 carbon atoms, e.g. in an alkyl, alkenyl or aryl substituted alkyl or alkenyl group with at least six aliphatic carbon atoms.

Other fabric softening agents are the corresponding tertiary amines and imidazolines, other aliphatic alcohols, esters, amines or carboxylic acids incorporating a C8 to C30 alky, alkenyl or acyl group, including esters of sorbitan and esters of polyhydric alcohols, mineral oils, polyols such as polyethylene glycol, and also clays.

Some specific instances of fabric softening agents as described in European Patent Application EP 0 695 166 B are:

1) Acyclic Quaternary Ammonium Compounds

Acrylic quaternary ammonium compounds of the formula N⁺(Q1-4)X— wherein each Q1 is a hydrocarbyl group containing from 15 to 22 carbon atoms, Q2 is a saturated alkyl or hydroxy alkyl group containing from 1 to 4 carbon atoms, Q3 may be as defined for Q1 or Q2 or may be a phenyl and X— as an anion preferably selected from halide, methyl sulphate and ethyl sulphate radicals.

Throughout this discussion of fabric softening agents the expression hydrocarbyl group refers to alkyl or alkenyl groups optionally substituted or interrupted by functional groups including —OH, —O—, —COHN— and —COO—.

Representative examples of these quaternary softeners include ditallow dimethyl ammonium chloride; ditallow dimethyl ammonium methyl sulphate; dihexadecyl dimethyl ammonium chloride; di(hydrogenated tallow)dimethyl ammonium methyl sulphate or chloride; di(coconut)dimethyl ammonium chloride dihexadecyl diethyl ammonium chloride; dibenhenyl dimethyl ammonium chloride.

Typical examples of commercially available materials in this class include: ARQUAD™ 2C, ARQUAD™ 2HT, ARQUAD™ 2T (all available from Ex Akzo Chemie) and PRAPAGEN™ WK, PRAPAGEN™ WKT, DODIGEN™ 1828 (all available from Hoechst).

2) Alkoxylated Polyamines

Alkoxylated polyamines of general formula N⁺(Q4Q5Q5)-[(CH₂)n-N⁺(Q5Q5)-]ₘQ11(1+m)X— as described in European Patent Application No. EP 0 797 406 A1.

Each Q₄ is a hydrocarbyl group containing from 10 to 30 carbon atoms. The Q₅ groups may be the same or different each representing hydrogen, (—C₂H₄O)ₚH, (C₃H₆O)_{q}H, (C₂H₄O)ₚ, (C₃H₆O)_{q},H, an alkyl group containing from 1 to 3 carbon atoms or the group (CH₂)ₙ,N(Q₅)₂; n and n′ are each an integer from 2 to 6, m is an integer from 1 to 5 and p, q and (p′+q′) may be numbers such that (p+q+p′+q′) does not exceed 25. X⁻ is an anion.

Alkoxylated polyamines suitable for use herein include N-tallowyl, NN′N′-tris (2 hydroxyethyl)-1,3-propane diamine di-hydro chloride; N-cocyl N,N,N′,N′ pentamethyl-1,3 propane diammonium dichloride or dimethosulphate; N-stearyl N,N′,N′ tris(2-hydroxyethyl) N,N1′dimethyl-1,3 propanediammonium dimethyl sulphate; N-palmityl N,N′,N′tris(3-hydroxypropyl)-1,3-propanediammonium dihydrobromide; N-tallowyl N-(3 aminopropyl)-1,3-propanediamine trihydrochloride.

3) Diamido Quaternary Ammonium Salts

Diamido quaternary salts of general formula Q1-C(O)NHQ6-N⁺(Q2Q5)-Q6-NHC(O)-Q1X— are also useful as fabric softening agents. Q6 is a divalent alkylene group containing from 1 to 3 carbon atoms. Q1, Q2, Q5 and X— are as defined previously.

Examples of suitable materials include: methylbis(tallowamidoethyl)(2-hydroxyethyl)ammonium methyl sulphate and methyl bis (hydrogenated tallowamido ethyl)(2 hydroxyethyl)ammonium methyl sulphate. These materials are available from Sherex Chemical Company under trade names VARISOFT™ 222 and VARISOFT™ 110 respectively and under the trade name ACCOSOFT™ from Stepan Corporation.

4) Ester Quaternary Ammonium Salts

A number of ester groups containing quaternary ammonium salts, including those disclosed in European Patent Publication Nos. EP 0 345 842 A2, EP 0 239 910 and U.S. Pat. No. 4,137,180, are useful as softening materials. These materials can be represented by generic formulae N⁺(Q7Q8Q9)-(CH₂)—Y-Z-Q10 and N⁺(Q2Q2R2)—(CH₂)n-CH(Z-Q10)-(CH₂)-Z-Q10.

In the former formula Q7 is a hydrocarbyl group containing 1 to 4 carbon atoms, Q8 is (CH2)n-Z-Q10 where n is an integer from 1 to 4 or -Q10. Q9 is an alkyl or hydroxyalkyl group of 1 to 4 carbon atoms, or is as defined for Q8. Q10, is a hydrocarbyl group containing from 12 to 22 carbon atoms and Y can be —CH(OH)—CH2- or Q6, as previously defined. Z can be —O—C(O)O—, —C(O)O—C(O)—O or —O—C(O)— and X— is an anion.

In the latter formula, the symbols Q2, Q10, Z and X— have the meanings defined previously and R2 is a C1-C30 alkyl C1-C30 group.

Suitable examples of suitable softener materials based on the former formula are N,N-di(tallowyl-oxyethyl)-N,N-dimethyl ammonium chloride; N,N-di(2-tallowyloxy-2-oxo-ethyl)-N,N-dimethyl ammonium chloride; N,N-di(2-tallowyloxyethylcarbonyl oxyethyl)-N,N-dimethyl ammonium chloride; N-(2-tallowloxy-2-ethyl)-N-(2-tallowyl oxo-2-oxyethyl)-N,N-dimethyl ammonium chloride; N,N,N-tri(tallowyl-oxyethyl)-N-methyl ammonium chloride; N-(2-tallowyloxy-2-oxyethyl)-N-(tallowyl-N,N-dimethyl)-ammonium chloride. Tallowyl may be replaced with cocoayl, palmoyl, lauryl, oleyl, stearyl and palmityl groups. A suitable example of a softener material of the latter formula is 1,2-ditallowyloxy-3-trimethyl ammoniopropane chloride.

Examples of commercially available materials can be obtained under the trade name STEPANTEX™ VRH 90 (available from Stepan), AKYPOQUAT™ (available from Chem-Y) and as mixtures of mono and ditallow esters of 2,3-dihydroxy propane trimethyl ammonium chloride (available from HOECHST Gmbh).

5) Quaternary Imidazolinium Salts

A further class of cationic softener materials is the imidazolinium salts of generic formula (C-Q7N-Q11 imadazolinium)-(CH₂)n-G-C(O)-Q10, wherein Q11 is a hydrocarbyl group containing from 6 to 24 carbon atoms, G is —N(H)—, or —O—, or NQ2, n is an integer between 1 and 4, and Q7 is as defined above.

Suitable imidazolinium salts include 1-methyl-1-(tallowylamido)ethyl-2tallowyl-4,5 dihydro imidazolinium methosulphate and 1-methyl-1-(palmitoylamido)ethyl-2-octadecyl-4,5-dihydroimidazolinium chloride. Representative commercially available materials are VARISOFT™ 475 (available from Sherex) and REWOQUAT™ W7500 (available from Rewo).

6) Primary, Secondary and Tertiary Amines and Their Protonated Forms.

Primary, secondary and tertiary amines of general formula N(Q11-13) and N(Q11-13)H⁺X⁻ are useful as softening agents, wherein Q₁₁ is a hydrocarbyl group containing from 6 to 24 carbon atoms, Q₁₂ is hydrogen or a hydrocarbyl group containing from 1 to 22 carbon atoms and Q₁₃ can be hydrogen or Q₇. The amines are protonated with hydrochloric acid, orthophosphoric acid or citric acid or any other similar acids for use in fabric softening compositions used in the invention.

7) Alkoxylated Amines

Alkoxylated amines of general formula N⁺(Q1Q14)-[(CH₂)₂—N(Q16)-]ₘQ15 are also useful as softener components of this invention, wherein Q₁₄ is (C₂H₄O)ₓH, Q₁₅ is (C₂H₄O)_{y}h and Q₁₆ is (C₂H₄O)_{z}H and x+y is within the range 2 to 15 and x+y+z is within the range 3 to 15, m can be 0, 1 or 2 and Q₁ is as previously defined. Examples of these softener materials include monotallow-dipolyethoxyamine containing from 2 to 30 ethylene oxide units, tallow N,N′,N′ tris(2-hydroxyethyl)-1,3 propylene diamine and C₁₀ to C₁₈ alkyl-N-bis(2-hydroxyethyl)amines. Examples of commercially available materials are available under the trade names ETHOMEEN™ and ETHODUOMEEN™ (Akzo Chemie).

8) Cyclic Amines

Other useful softener materials include dialkyl cyclic amines represented by formula cyclo-[A-(CH₂)ₙ—N—C(Q17)]-B-Q17, wherein the groups Q₁₇ are independently selected from hydrocarbyl groups containing from 8 to 30 carbon atoms and A can be oxygen (—O—) or nitrogen (—N═) preferably nitrogen; B is selected from Q₆ as defined earlier or the group -Q₁₈-T-C(O)— where Q₁₈ is either Q₆ or (—C₂H₄O—)ₘ with m being an integer from 1 to 8 and T being selected from oxygen and NQ₁₃.

Suitable examples of such softener materials include 12-stearyl oxyethyl-2-stearyl imidazoline, 1-stearyl oxylethyl-2-palmityl imidazoline, 1-stearyl oxyethyl myristyl imidazoline, 1-palmityl oxyethyl-2-palmityl imidazoline, 1-palmityl oxyethyl-2-myristyl imidazoline, 1-stearyl oxyethyl-2-tallow imidazoline, 1-myristyl oxyethyl-2-tallow imidazoline, 1-palmityl oxyethyl-2-tallow imidazoline, 1-coconut oxyethyl-2-coconut imidazoline, 1-tallow oxyethyl-2-tallow imidazoline and mixtures thereof. Also useful is stearyl hydroxyethyl imidazoline, available commercially as ALKAZINE™ (Alkaril), 1-tallow amido ethyl-2-tallow imidazoline and Methyl-1-tallow amidoethyl-2-tallow imidazoline.

Yet another class of suitable fabric softening materials include condensation products formed from the reaction of fatty acids with a polyamine selected from the group consisting of hydroxyalkyl, alkylene diamines and dialkylenetriamines and mixtures thereof. Suitable materials are disclosed in European Patent Publication EP 0 199 382 A1. Included among these are mixtures of molecules of the generic formula Q1-C(O)NHQ6-N(WQ6-OH) and corresponding salts obtained by partial protonation, wherein W is selected from hydrogen and the group —C(O)-Q₁ and other symbols are as previously defined. Commercially available materials of this class can be obtained from Sandoz Products as Ceranine™ HC39, HCA and HCPA.

9) Zwitterionic Fabric Softeners

Other useful ingredients of softening systems include zwitterionic quaternary ammonium compounds such as those disclosed in European Patent Publication EP 0 332 270 A2. Representative materials in this class are illustrated by general formula N⁺(Q11Q19Q19Q20)Z- and Q11-C(O)NHQ20-N⁺(Q19Q19Q20) Z-, wherein the groups Q19 are selected independently from Q7, Q11 and Q14; Q20 is a divalent alkylene group containing 1 to 3 carbon atoms and may be interrupted by —O—, —COHN, —C(O)O—, and the like; and wherein Z- is an anionic water solubilizing group (e.g. carboxy, sulphate, sulpho or phosphonium).

Examples of commercially available materials include the EMPIGEN™ CD and BS series (Albright Wilson) the REWOTERIC™ AM series (Rewo) and the Tegobetain™ F, H, L and N series (GOLDSCHMIDT). Other suitable examples of fabric softeners and components that constitute softeners are described in European Patent Publication EP 1 111 034 A1 and U.S. Pat. No. 6,194,375.

10) Non-ionic Ingredients

It is well known to blend non-ionic materials with cationic amphoteric or zwitterionic softening materials as a means of improving dispersion of the product in rinse waters and enhancing the fabric softening properties of the softener blend.

Suitable non-ionic adjuncts include lanolin and lanolin derivatives, fatty acids containing from 10 to 18 carbon atoms, esters or fatty acids containing from 8 to 24 carbon atoms with monohydric alcohols containing from 1 to 3 carbon atoms, and polyhydric alcohols containing 2 to 8 carbon atoms such as sucrose, sorbitan, together with alkoxylated fatty acids, alcohols and lanolins containing an average of not more than 7 alkylene oxide groups per molecule. Suitable materials have been disclosed in European Patent Publication Nos. EP 0 885 200 A, EP 0 122 141, Great Britain Patent Nos. GB 2,157,728 A, GB 8,410,321, European Patent Publication Nos. EP 0 159 918 A, EP 0 159 922 A and EP 0 797 406 (Procter & Gamble).

Fabric softening compositions generally do not include anionic detergent actives, bleach, or detergency builders. It is desirable that the amounts (if any) of anionic detergent active, bleach and detergency builder are all less than the amount of the fabric softening agent.

A fabric softening composition which is intended to be added to rinse water may be in the form of a solid, a powder or tablet for instance, which disperses in the rinse water.

More commonly, a fabric softening composition for addition to rinse water is in the form of a liquid, and is an aqueous dispersion in water. Such a fabric softening composition may contain from 1%, including 2% up to 30% including 40% by weight of a fabric softening agent. Optionally, it is reasonable and within the scope of the invention that certain fabric softening compositions will include higher levels from 40% up to 80%, including 90% by weight in a very concentrated product. The composition will usually also contain water, which may provide the balance of the composition.

Liquid fabric softening compositions are customarily prepared by melting the softening ingredients and adding the melt to hot water, with agitation to disperse the water-insoluble ingredients.

Perfume-carrying particles according to this invention may be added as dry particles or as an aqueous slurry, suitable after the composition has cooled.

Liquid fabric softening compositions can be prepared by simply mixing the ingredients, including water, with agitation to disperse the water-insoluble ingredients.

Solid softening (also referred to as conditioning) articles which release a fabric softening agent in a tumble dryer can be designed for single usage or multiple usage.

One such article comprises a sponge material releasably enclosing a composition containing fabric softening agent and perfume so as to impart fabric softness and deodorancy during several drying cycles. This multi-use article can be made by filling a hollow sponge with the composition. In use, the composition melts and leaches out through the pores of the sponge to soften fabrics. Such a filled sponge can be used to treat several loads of fabrics in conventional dryers, and has the advantage that it can remain in the dryer after use and is not likely to be misplaced or lost.

Another article comprises a cloth or paper bag releasably enclosing such a composition and sealed with a hardened plug of the mixture. The action and heat of the dryer opens the bag and releases the composition to perform its softening and delivery of deodorant perfume function.

According to an alternative embodiment of the invention, the rheology controlling composition of the invention is included in a fabric softening article that comprises a composition containing the softening agent and deodorant perfume releasably impregnating a sheet of woven or non-woven cloth substrate. When such an article is placed in a tumble dryer the heat and tumbling action removes the softening composition from the substrate and transfers it to the fabrics. A solid product for use in a tumble dryer will generally contain fabric softening agent in an amount from 40% to 95% by weight of the product.

The amount of perfume incorporated in a fabric softening product is from 0.01% to 10% by weight.

For fabric conditioning liquids containing less than 40% by weight of fabric softening agent, the amount of perfume is typically 0.1 to 3% by weight, including 0.1 to 1.5%, including 0.1% to 1%, and including 0.1% to 0.3%.

The amount of perfume in very concentrated fabric conditioning liquids is in the broader range up to 10% by weight, including 2% to 8% by weight, and 3% to 6% by weight.

The amount of perfume in products for use in a tumble dryer is from 2% to 4% by weight of the product.

The deodorant effectiveness of a detergent or other composition which incorporates a perfume composition in accordance with this invention can be assessed by testing in accordance with Odour Reduction Value or Malodour Reduction Value tests as specified in the prior documents mentioned initially. These are based on the test devised by Whitehouse and Carter as published in “The proceedings of the Scientific Section of the Toilet Goods Association”, No 48, December 1967 at pages 31-37 under the title “Evaluation of Deodorant Toilet Bars”. For fabric conditioning compositions a suitable test procedure is a Malodour Reduction Value test based on that described in U.S. Pat. No. 4,663,068 A1. It is derived from the original Whitehouse and Carter test.

Another form of fabric softening product has a fabric softening agent in a composition which is coated onto a substrate, usually a flexible sheet or sponge, which is capable of releasing the composition in a tumble dryer. Such a product can be designed for single usage or for multiple uses. One such multi-use article comprises a sponge material releasably enclosing enough of the conditioning composition to effectively impart fabric softness during several drying cycles. The multi-use article can be made by filling a porous sponge with the composition. In use, the composition melts and leaches out through the pores of the sponge to soften and condition fabrics. A single use sheet may comprise the inventive compositions carried on a flexible substrate such as a sheet of paper or woven or non-woven cloth substrate. When such an article is placed in an automatic laundry dryer, the heat, moisture, distribution forces and tumbling action of the dryer removes the composition from the substrate and deposits it on the fabrics. Substrate materials for single use and multiple use articles, and methods of impregnating or coating them are discussed in U.S. Pat. No. 5,254,269 and elsewhere.

A fabric softening product which is an impregnated or coated sheet, sponge or other substrate will typically contain perfume-carrying particles in a quantity to provide from 0.5 to 8% by weight perfume, preferably from 2% or 3% up to 6%.

Attempts have been made to increase fragrance deposition onto fabric and to hinder or delay the release of the perfume so that the laundered fabric remains aesthetically pleasing for a prolonged length of time. One approach used a carrier to bring the fragrance to the clothes. The carrier is formulated to contain a fragrance and to attach itself to the clothes during the washing cycle through particle entrainment or chemical change.

Perfumes have been adsorbed onto various materials such as silica and clay to deliver perfume in detergents and fabric softeners. U.S. Pat. No. 4,954,285 discloses perfume particles especially for use in dryer released fabric softening/anti-static agents. The perfume particles are formed, by adsorbing the perfume onto silica. The particles have a diameter of greater than about one micron. The particles can be used to reduce the shiny appearance of visible softener spots, which occasionally are present on fabrics treated with said fabric softening compositions and to maintain a relatively constant viscosity of the molten softening composition. The perfume particles are especially adapted for inclusion in dryer activated solid fabric softener compositions including coated particles of fabric softener, which are added to a detergent composition for use in the washing of fabrics. The compositions release softener to the fabrics in the dryer and improve the aesthetic character of any fabric softener deposits on fabrics. The perfume particles can also be admixed with detergent granules and can either be coated or uncoated. This system has the drawback that the fragrance oil is not sufficiently protected and is frequently lost or destabilized during processing.

As used herein, polymers which are water insoluble are preferably readily dispersible in water. As used herein, the term “water soluble”, as applied to polymers, indicates that the polymer has a solubility of at least 1 gram per 100 grams of water, preferably at least 10 grams per 100 grams of water and more preferably at least about 50 grams per 100 grams of water. The term “water insoluble”, as applied to polymers, refers to monoethylenically unsaturated polymers which have low or very low water solubility under the conditions of emulsion polymerization, as described in U.S. Pat. No. 5,521,266. An aqueous system refers to any solution containing water.

The cationic emulsion polymers of the invention stabilize the rheology of softeners that include fragrance and softeners that include added fragrance, in both instances affording softeners whose respective viscosities do not increase over time.

As used herein, the term “neat fabric softeners” refers to softeners containing no fragrance. It is well known in the art that quaternary surfactant systems in neat fabric softeners form vesicular micelles. Addition of hydrophobic fragrance causes changes in the morphology of the micelles. It is believed that spherically shaped neat quaternary surfactant components in the softener structurally change over time in to rod-like micelles upon addition of fragrance to a softener. The elongated geometry of the micelles is one primary reason the softener viscosity increases over time.

Inventors took several approaches to solve the rheology instability problem of softeners, manifesting in increased softener viscosities for softeners that include fragrance and softeners that include added fragrance. Inventors tested a number of rheology modifiers as agents to control the rheology of softeners that include fragrance and softeners that include added fragrance. Suitable emulsion polymers utilized included hydrophobically modified urethane thickeners (so called HEUR thickeners), oligomer compositions obtained from emulsion polymerization including cationic and anionic seeds, wherein the oligomers function as a delivery vehicle (also referred to as a carrier) and cationic emulsion polymers. Inventors discovered that both oligomer compositions and cationic emulsion polymers stabilize and control the viscosity of fabric softeners including Downy Free™.

Some embodiments of the invention are described in detail in the following Examples. All ratios, parts and percentages are expressed by weight unless otherwise specified, and all reagents used are of good commercial quality unless otherwise specified. The following abbreviations are used in the Examples:
DMAEMA=Dimethylaminoethylmethacrylamide
MMA=Methyl Methacrylate
EGDMA=Ethyleneglycol Dimethacrylate
BzCl=Benzyl Chloride

### EXAMPLES

### Preparation of Softeners Including Added Fragrance and a Cationic Emulsion Polymer

Cationic latex polymers were prepared similarly to the method described in U.S. Pat. Nos. 3,847,857 and 5,312,863. A representative example include a commercially available latex polymer Rhoplex™ PR-26 (Rohm and Haas Company, Philadelphia Pa.). The emulsion polymer has solids content of 30% by weight, a pH of 7.0 to 8.0 and has been independently tested and found to be non-toxic and non-irritating. Toxicity testing included both oral and skin absorption. Two commercially available fragrance formulations A and B were obtained and used. The fragrance formulation A is a full spectrum formulation useful in both consumer care and personal care products. It contains more than 50 fragrant compounds. The fragrance formulation B is a partial formulation, including only top note fragrant compounds. A commercially available softener, Downy Free™ rinse dosed fabric softener was obtained and used (Proctor and Gamble Corporation, Cincinnati, Ohio). It is a milky white dispersion, having a surface active content (as ester quats) of 25% by weight, a pH of 3.0 to 3.5 and a viscosity of 50 centipoise at 25° C.

Softener Formulations Including Added Fragrance.

Downy Free™ rinse dosed fabric softener including 2 to 3% by weight of fragrance formulations A and B, respectively, and Rhoplex™ PR-26 were prepared. A typical procedure for preparing softener formulations is given as following:

Fragrance and deionized water (DI) mixture were homogenized for three minutes. Cationic emulsion polymer latex was added to the water and fragrance mixture. The resulting mixture was stirred at 80° C. for 2 hours using a heated water bath. The mixture was added to softener. The softener including the added mixture was agitated using stirring or shaking for 3 hours. Viscosity was measured after preparation and over time, storing the prepared formulation at 40° C.

The prepared softener formulations including controls and comparatives are summarized in Table 1.

TABLE 1
Softener Formulations

| Sample | Fragrance (g) | DI (g) | PR-26 ™ TM (28% solids) | Softener |
|---|---|---|---|---|
| 1^{a} | 1.2 | 0 | 0 | 60 |
| 2^{b} | 1.4 | 6.4 | 5 | 57.2 |
| 3^{c} | 1.4 | 6.4 | 5 | 57.2 |

^{a}Control.
^{b}Softener + 2 wt. % A.
^{c}Softener + 2 wt. % B.

Viscosity of prepared softener formulations was measured using a Brookfield rheometer, frequency 12 and spindle 2 settings were used for all measurements.

From measured viscosity data in aging tests at 40° C., softener containing added fragrance and no cationic emulsion polymer resulted in increased viscosity of the formulation over time. The viscosity of the softener and 2 weight percent of fragrance formulation A ranged from 200 cps to 775 cps at the end of 8 weeks time. The viscosity of the softener and 2 weight percent of fragrance formulation B ranged from 20 cps to 14,500 cps at the end of 8 weeks time. Viscosity measurements of softener containing added fragrance and added cationic emulsion polymer resulted unexpectedly in stabilized viscosity of the formulation over time. The viscosity of the softener and 2 weight percent of fragrance formulation A ranged from 25 cps to 160 cps at the end of 8 weeks time, consistent with the viscosity of neat softener containing no added fragrance (20 to 187 cps). The viscosity of the softener and 2 weight percent of fragrance formulation B ranged from 50 cps to 1375 cps at the end of 8 weeks time, consistent with the viscosity of neat softener containing no added fragrance (50 to 600 cps). When fragrance formulation A or B was delivered with the cationic emulsion polymer to the softener, the resulting viscosity of the softener formulation including added fragrance remained stable and did not significantly increase. For added fragrance formulation A the viscosity was reduced or stabilized four times compared with softener containing no added cationic emulsion polymer. For added fragrance formulation B the effect was more pronounced and the viscosity was reduced or stabilized greater than ten times compared with softener containing no added cationic emulsion polymer. It is well known in the art of fragrance that so called top note fragrances such as B are difficult to add to softeners as a result of rheology instability over time. The inventors cationic emulsion polymers are effective in controlling the rheology of rinse dosed fabric softeners and help to inhibit a rise in the viscosity of such softeners over time.

1. A softener composition comprising one or more cationic emulsion polymers and one or more fragrances, wherein addition of the cationic emulsion polymers to the softener stabilizes softener viscosity.

2. The composition according to claim 1, wherein the viscosity of the softener is maintained as compared to the viscosity of the softener comprising fragrance and no cationic emulsion polymer.

3. The composition according to claim 1, wherein the fragrances are water insoluble mixtures of fragrant compounds; and wherein the cationic emulsion polymers oligomer compositions are obtained from emulsion polymerization using cationic and anionic seeds.

4. A process for stabilizing the viscosity of one or more softeners comprising the steps of: (a) combining one or more cationic emulsion polymers and one or more fragrances; and (b) adding the combination to the softener.

5. The process according to claim 4, wherein softener viscosity is maintained as compared to the viscosity of a respective softener comprising one or more fragrances and no cationic emulsion polymer.

6. The process according to claim 4, wherein the one or more fragrances are water insoluble mixtures of fragrant compounds; and wherein the cationic emulsion polymers oligomer compositions are obtained from emulsion polymerization using cationic and anionic seeds.

7. The process according to claim 4, wherein the softener including fragrance and one or more cationic emulsion polymers is incorporated into compositions and formulations selected from the group consisting of personal care, cosmetic, consumer, pharmaceutical products and combinations thereof.

8. A softener formulation comprising: (a) one or more cationic emulsion polymers and (b) one or more fragrances; wherein addition of a mixture of (a) and (b) to the softener formulation stabilizes softener formulation viscosity.

9. The softener formulation according to claim 8, wherein softener formulation viscosity is maintained as compared to the viscosity of a respective softener comprising fragrance and no cationic emulsion polymer.
